(19) United States
(12) Patent Application Publication
(10) Pub. No.: US 2006/0088807 A1
(43) Pub. Date: Apr. 27, 2006

(54) Prayer/blessing kit

(76) Inventors: Shane A. Lee, Kapolei, HI (US); Monica Lee, Kapolei, HI (US)

Correspondence Address: Richard C. Litman;LITMAN LAW OFFICES, LTD., P.O. Box 15035, Arlington, VA, 22215, US

(21) Appl. No.: 10/969,352

(22) Filed: Oct. 21, 2004

(51) Int. Cl. G09B 19/00

(52) U.S. Cl. 434/245

(57) ABSTRACT

The prayer/blessing kit has a storage container having disposed therein instruction sheets for administering a blessing, a quantity of a mineral, and at least one prayer sheet having imprinted thereon prayers to be recited while administering the blessing. The prayer sheets may be optionally disposed in at least one receptacle. The prayer/blessing kit may also optionally include a leaf. The prayer/blessing kit allows individuals who are not officials of a religious institution to administer a blessing. The prayer/blessing kit can be easily transported by a user from place to place and can be used to bless a home, office, vehicle or any other desired object or location

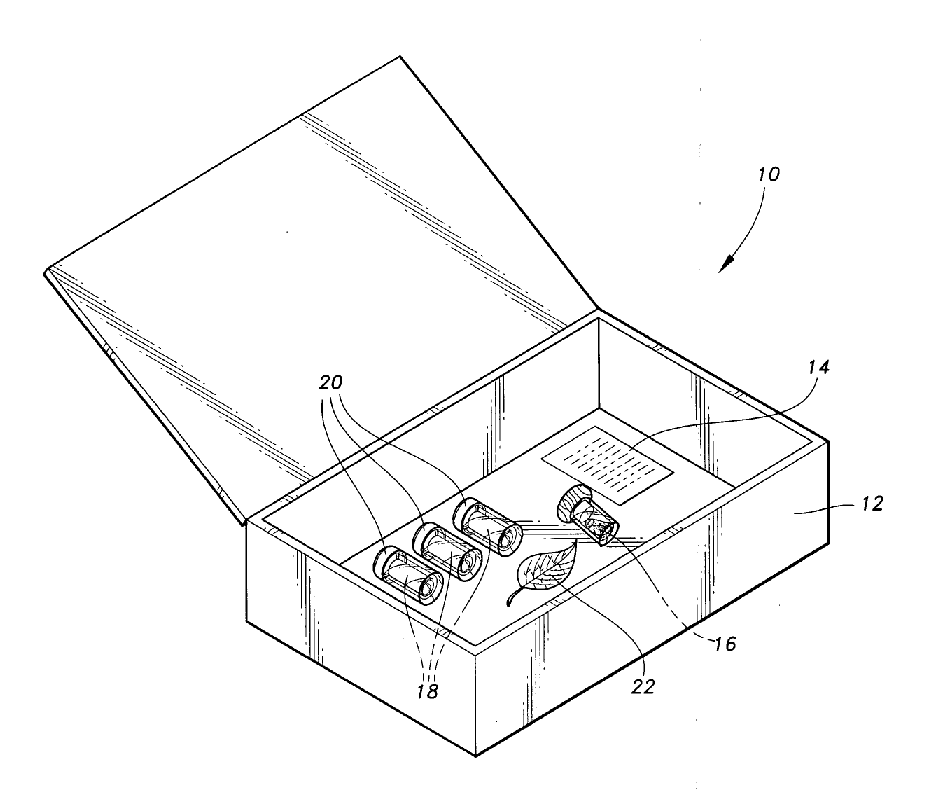

### BACKGROUND OF THE INVENTION

1. Field of the Invention

The present invention relates to a prayer kit, and more particularly, to a kit that includes articles necessary for performing religious rites and rituals, such as house blessings.

2. Description of the Related Art

Many individuals generally feel that they are not capable of performing certain religious rituals that they believe are necessary for blessing a home, office, vehicle or any desired object or location. This may be because most people are not familiar with the prayers that must be recited for a certain blessing or the articles that are necessary to complete a particular ritual. As such, most people seek the assistance of priests or other officials of a religious institution to perform such religious rituals. However, since priests and other clergy are not always available when needed, it is often difficult to obtain a desired blessing.

Thus, a prayer/blessing kit solving the aforementioned problems is desired.

### SUMMARY OF THE INVENTION

The prayer/blessing kit includes a storage container having disposed therein instruction sheets for administering a blessing, a quantity of an aggregate mineral, and at least one prayer sheet having imprinted thereon prayers to be recited while administering the blessing. Each prayer sheet may be optionally disposed in at least one receptacle. In one embodiment, the prayer/blessing kit may further include a leaf. The prayer/blessing kit allows individuals who are not officials of a religious institution to administer a blessing. The prayer/blessing kit can be easily transported by a user from place to place and can be used to bless a home, office, vehicle or any other desired object or location.

These and other features of the present invention will become readily apparent upon further review of the following specification and drawings.

### BRIEF DESCRIPTION OF THE DRAWINGS

The sole FIGURE is a perspective view of a prayer/blessing kit according to the present invention.

### DETAILED DESCRIPTION OF THE PREFERRED EMBODIMENTS

The present invention relates to a prayer/blessing kit, generally designated as 10 in the drawing. The prayer/blessing kit 10 includes a storage container 12 having disposed therein one or more sheets of instructions 14 for carrying out a blessing, a second container, a quantity of an aggregate mineral 16 disposed in the second container, and one or more sheets of prayers 18 with prayers imprinted thereon to be recited while administering the blessing. While the storage container 12 is depicted as a box having a lid in the drawings, the storage container 12 can be any type of receptacle appropriate for containing articles required for worship or prayer. Thus, the storage container 12 may be, for example, a plastic bag, an envelope, a jar, a purse, or a briefcase.

The mineral 16 can be salt or any other natural crystalline element or compound. Salt is particularly well known as having significance in religious ceremonies in the Judeo-Christian heritage, as well as other religious traditions, probably stemming from its use as a preservative, cleanser and purifier. As is shown, the mineral 16 may be disposed in a small bottle or capped vial, or it may be disposed in a ZipLoc® bag, decorative envelope, or other suitable container.

Each prayer sheet 18 may be optionally disposed in a receptacle 20, as is shown. The receptacle 20 may be, for example, a plastic or glass vial. If a user wishes to bless a new home that is undergoing construction, the receptacle 20 containing the prayer sheets 18 may be embedded in the walls of the home. The prayer sheets 18 have various prayers imprinted thereon directed towards particular ends that the kit 10 may be direct towards, e.g., blessings for homes, blessings for boats or vehicles, etc. The particular words or language of the prayers does not form part of the present invention, as various prayers for the objects recited are well known, and vary among the denominations and faiths.

Although not required, the prayer/blessing kit 10 may further include a leaf 22. In accordance with the instruction sheets 14, a prayer may be recited over the leaf 22 in order to bless the leaf 22. Once the leaf 22 is blessed, the leaf 22 may be carried on one's person or left in a place that one desires to be blessed.

The instructions for administering a blessing may vary. An example of instructions for blessing a home may be as follows:
1. Clear your mind of negative thoughts.
2. Place a quantity of salt in a bowl.
3. Recite a prayer, such as the Lord's Prayer, seven times over the bowl containing the salt.
4. Sprinkle salt from bowl in a counter-clockwise direction around the interior of the home along the walls while reciting a home prayer or blessing.
5. Proceed to sprinkle salt outside of the home along the property lines while reciting the home prayer or blessing.

The prayer/blessing kit allows individuals who may not be officials of a religious institution to perform a blessing ritual. The prayer/blessing kit can be easily transported by a user from place to place and can be used to bless a home, office, vehicle or any other desired object or location.

It is to be understood that the present invention is not limited to the embodiments described above, but encompasses any and all embodiments within the scope of the following claims.

We claim:

1. A prayer/blessing kit, comprising:
a storage container;
at least one sheet of instructions for administering a blessing;
a second container disposed in said storage container;
a quantity of an aggregate mineral disposed in said second container;
at least one sheet of prayers for recitation while administering the blessing.

2. The prayer/blessing kit of claim 1, wherein the storage container is a box.

3. The prayer/blessing kit of claim 1, wherein the storage container is an envelope.

4. The prayer/blessing kit of claim 1, wherein the storage container is a jar.

5. The prayer/blessing kit of claim 1, wherein the storage container is a purse.

6. The prayer/blessing kit of claim 1, wherein the storage container is a briefcase.

7. The prayer/blessing kit of claim 1, wherein the mineral is salt.

8. The prayer/blessing kit of claim 1, further comprising a receptacle, said prayer sheet being disposed in the receptacle.

9. The prayer/blessing kit of claim 1, further comprising a vial, said prayer sheet being disposed in the vial.

10. The prayer/blessing kit of claim 1, further including a leaf disposed in said storage container.

11. The prayer/blessing kit of claim 1, wherein said second container comprises a capped vial.
